(19) United States
(12) Patent Application Publication
(10) Pub. No.: US 2008/0281654 A1
(43) Pub. Date: Nov. 13, 2008

(54) Data center life cycle management

(75) Inventors: Stephen R. Carter, Spanish Fork, UT (US); Robert A. Wipfel, Draper, UT (US)

Correspondence Address: KING & SCHICKLI, PLLC, 247 NORTH BROADWAY, LEXINGTON, KY, 40507, US

(73) Assignee: Novell, Inc.

(21) Appl. No.: 11/801,375

(22) Filed: May 9, 2007

(51) Int. Cl. G06Q 99/00

(52) U.S. Cl. 705/7

(57) ABSTRACT

Managing a data center life cycle of an enterprise begins with a policy defining stages of the life cycle and criteria indicating a successful evaluation of each stage. Evaluators, according to a predetermined identity, attest to whether the policy is satisfied for a single stage of the life cycle until all stages are evaluated, but advancement from one stage to the next only occurs upon the policy being satisfactorily met. If the policy is not met, corrective action is taken, including an optional step of notifying personnel of a stage failure. Documenting the attestation is another consideration as is auditing the documenting. In this manner, troubleshooting is enhanced or an historical record is achieved. In the event of multiple evaluators, each may attest to the satisfaction of a portion of the policy. Further definitions include computing configurations per a single machine and/or an entirety of the data center.

### FIELD OF THE INVENTION

Generally, the present invention relates to computing system environments involving data centers. Particularly, it relates to comprehensively managing the life cycle of the data center as it progresses in a life cycle from inception, to testing, to revisions, to limited deployment, to full deployment, for example. Policy sets the parameters for defining stages of the life cycle as well as the criteria for successful evaluation thereof. Attestation to each stage occurs by evaluators having specified identities or roles and advancement to a next stage occurs only upon successful evaluation of a previous stage. Various specific features relate to testing, documenting, notice and auditing functions, machine and data center configurations, to name a few.

### BACKGROUND OF THE INVENTION

The processes running in a data center, for example, are rapidly becoming more complex as a result of “virtualization.” While virtualizing is solving a myriad of computing problems, the practice is beginning to surface new issues unique to the practice of virtualized data centers having high-density. Further, as regulatory pressures require that data center configurations be certified and regularly re-certified, more and more complex data centers will rapidly overload an enterprise's ability to keep all configurations under control and certified for completeness. To the extent enterprises presently keep up with evolving regulations, the changes implemented are often ad hoc or piecemeal. They also regularly avoid global or enterprise-wide visibility because of their complexity or time/financial constraints in which deployed. Human employees implementing the changes sometimes have little, if any, management oversight which can compromise enterprise knowledge of the events or even security.

Accordingly, a need exists in the art of data centers to eliminate ad hoc and piecemeal development, testing, deployment, etc., as future needs evolve the center. It further should contemplate a paradigm of comprehensiveness that services the functionality of the data center in both the short term and over time to eliminate knowledge and security compromises. Contemplation of governance scenarios and identity awareness is also relevant as are computing configurations, certifications, testing, noticing and auditing functions. Naturally, any improvements along such lines should further contemplate good engineering practices, such as relative inexpensiveness, stability, ease of implementation, low complexity, unobtrusiveness, etc.

### SUMMARY OF THE INVENTION

The above-mentioned and other problems become solved by applying the principles and teachings associated with the hereinafter-described data center life cycle management. In a departure from traditional evaluation, operation, improvement, etc., of data centers, the present invention contemplates dividing the life cycle of a data center into discrete stages that undergo an approval process (involving review, evaluation, and disposition) before being allowed to advance to a next stage of the process. In a representative embodiment, the life cycle begins with a policy defining the discrete stages and criteria indicating a successful evaluation of each stage. Evaluators, established according to their workplace identities or roles, attest to whether the policy is satisfied for a single stage of the life cycle until all stages are evaluated. Advancement from one stage to the next occurs only upon the policy being satisfactorily met. In this manner, the entirety of the data center stages from inception as a single computing device, for example, to testing, to limited deployment, to revisions, to an enterprise-wide deployment of a certain functionality is comprehensively known and attested-to for at all times. It overcomes the prior art deficiencies associated with ad hoc and piecemeal management.

In other embodiments: corrective action is undertaken to satisfy failed policies; notifying personnel occurs upon the failure of a stage; documenting the attestation occurs per stage; and auditing the documenting is available for troubleshooting and/or verifying the following of procedures. In the event multiple evaluators are use to attest to the satisfactory completion of a stage, each may attest to satisfying a portion of the policy, whereby the entirety of the evaluators are needed before advancement to the next stage. Still other embodiments contemplate defining a computing configuration per single machines of the data center and/or the entirety of the data center. Virtual machines are other noteworthy features as are computing subnets, security definitions and storage bindings. Computer program products with executable instructions, available as a download or on a computer-readable media, are also contemplated for implementing some or all of the foregoing on one or more physical computing devices.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a combined flow chart and diagrammatic view in accordance with the present invention of a representative life cycle management for a data center;

FIG. 2 is a flow chart in accordance with the present invention of a high-level organization for managing the life cycle of a data center; and

FIG. 3 is a combined flow chart and diagrammatic view in accordance with the present invention of a more detailed version of FIGS. 1 and 2.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software, process and/or other changes may be made without departing from the scope of the present invention. In accordance with the present invention, methods and apparatus for managing the life cycle of a data center are hereinafter described. In a basic sense, the management begins with a policy defining the life cycle as discrete stages including criteria indicating a successful evaluation of each stage. One or more evaluators based on their workplace identities or roles attest to whether the policy is satisfied for a single stage of the life cycle until all stages are evaluated. Advancement from one stage to the next occurs only upon the policy being satisfactorily met. In this manner, the entirety of the data center life cycle is comprehensively known from inception to full deployment and overcomes ad hoc management.

Data centers have long been known in the art and are not described herein in detail. Newly deployed definitions on data center operation, management, computing environments, etc., however, include the notion of tessellated applications. For this, reference is taken to: 1) U.S. patent application Ser. No. 11/784,869, having a filing date of Apr. 10, 2007, entitled “Tessellated Virtual Machines for Common Computing Goals,” filed by common assignee Novell, Inc. with listed inventors Stephen R Carter and Robert A. Wipfel; and 2) U.S. patent application Ser. No. 11/731,062, having a filing date of Mar. 30, 2007, entitled “Tessellated Virtual Machines Conditionally Linked for Common Computing Goals,” filed by common assignee Novell, Inc. with listed inventors Stephen R Carter and Carolyn B. McClain; the entireties of which are incorporated herein by reference as if fully set forth herein.

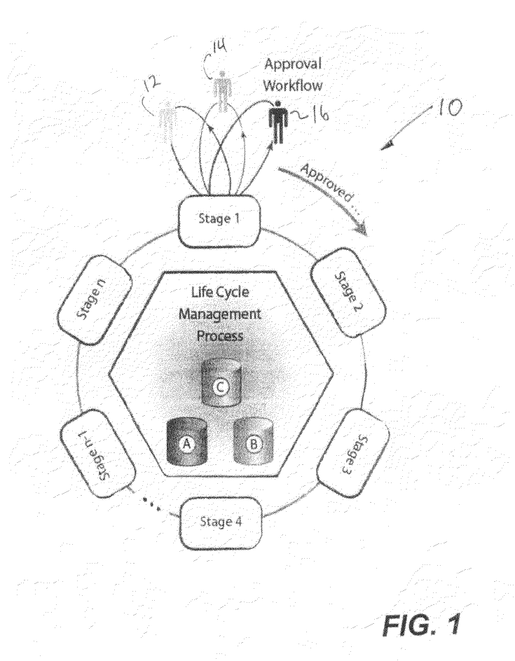

With reference to FIG. 1, a high-level organization 10 for managing the life cycle of a data center first includes dividing or apportioning the life cycle into multiple discrete stages, 1, 2, 3, 4 . . . n−1, n. Representatively, stages include (in no particular order): inception or conception of the data center (in an entirety or on a functionality basis), establishing pilot programs, deployment of the data center (in whole or part) on a limited basis to ensure its success, revising the data center (in whole or part), and deployment of the data center (in whole or part) on an enterprise-wide basis. Of course, other stages are possible and skilled artisans can readily contemplate them.

Based upon policy or other course of action guiding decisions of an organization, A serves to define the computing configuration data, B defines the policy itself, and C defines the attestation certifications. In more detail, the computing configuration data A contemplates items such as, but not limited to, defining each individual computing machine in the data center (whether virtual or per hardware), defining the entirety of machines as a compilation working toward the common goal of the data center, defining acceptance and deployment tests, defining computing environments, such as subnets, security definitions, storage bindings, software, etc.

Under B, the policy itself is vast and representatively contemplates items such as who, what, where, when, why and/or how the data center is managed. In this regard, the “who” contemplates identities of individuals in the organization who can approve certain stages, who can audit certain stages, who can make revisions, who can define computing machines, who can define data center functionality, who has managerial oversight, who has reporting responsibility, etc. The “what” contemplates that which will be managed. For example, it may be necessary to identify whether hardware, electricity, software, firmware, power consumption, wiring (cabling), etc., or what portions thereof, if any, are part of the managed life cycle. The “where” contemplates the locations of hardware or functionality of the data center. In one instance, this may be physical geographical, such as per a given city of an entity or in which rooms of the building (layout) certain items exist. In the alternative, it may be a virtual definition of various virtual machines performing certain computing roles. The “when” contemplates timing decisions, such as how long a stage should take, how long testing periods should last, etc. Timing diagrams are also useful and found in Gantt Charts or the like. The “why” contemplates definitions of authority, such as laws like the Sarbanes-Oxley Act, rules, guidelines, etc. that dictate the rationale for acting one way or another in the management of the entirety or individual components of the life cycle. The “how” contemplates management execution, such as logistics for arranging people and assets together at the appropriate times and places to accomplish the particular task at hand.

At C, the attestation certifications contemplate documenting the management to provide lasting attestation to the items of policy B and computing configurations A, per one or more stages of the life cycle. As seen below, they can be written and/or electronic thereby lending themselves to temporary or permanent storage, in turn, lending to auditing or troubleshooting.

Together, the triumvirate of A, B, and C are components that one or more evaluators 12, 14, 16 utilize in attesting to the satisfactory completion of a single stage of the life cycle. In a basic sense, the computing configuration data A of the life cycle at stage 1 is examined per the policy B and that, before moving to the next stage 2 (e.g., from development to testing), undergoes an approval process by the evaluators that involves review, evaluation, and disposition, e.g., the attestation C. If approved, management of the life cycle progresses to the next stage where the evaluation again takes place per a set of evaluators, computing configuration data and policy per that stage. If approved there, it advances to the next stage until all “n” stages are complete. In this manner, the entirety of the data center stages from inception to an enterprise-wide deployment of a certain functionality is comprehensively known and attested to for all times.

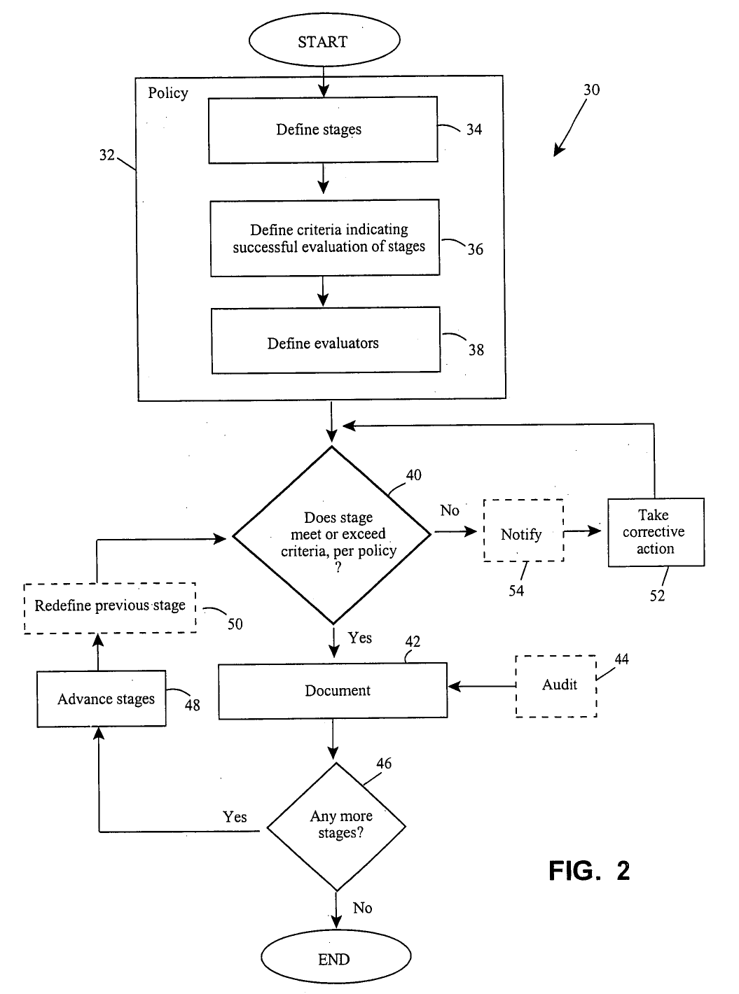

In FIG. 2, a more detailed flow chart is given generically as 30. Under the rubric of a policy 32, various definitions are set. First, the stages of the life cycle are defined at step 34. As before, this includes dividing or apportioning the life cycle into multiple discrete stages that can be evaluated, per policy, and attested-to independent of other stages. Representative stages include inception, pilot programs, testing, limited deployment, revision, full deployment, etc.

Second, one or more criteria indicating a successful evaluation of the stages are defined at step 36. Representative criteria include, but are not limited to, establishing tests, work-flows, or other objective or subjective metric by which people can understand whether a computing configuration of a stage meets or fails the criteria, per the policy.

Third, the evaluator(s) per each stage who attest to the satisfaction of the criteria being met (or not), per the policy, are defined at step 38. The evaluators are also likely picked, as before, according to their workplace identity or role. For instance, a system administrator may be an evaluator suited to determine whether a computing configuration includes enough computing memory to undertake financial software of an accounting department of an enterprise. An electrician, on the other hand, may be an evaluator suited to determine whether the accounting department has enough electrical power to run the servers hosting the financial software. An accountant, as evaluator, may be still a third person involved in assessing whether the financial software will satisfactorily accomplish the accounting tasks of the enterprise. Of course, other scenarios are likely that skilled artisans will readily understand. The foregoing, therefore, is only an example.

At step 40, the actual evaluation of the stage occurs, per the criteria, in turn set forth as part of the policy. If it is determined the evaluation of the stage reveals a satisfactory achievement of the criteria, the results are documented (written and/or electronic), at step 42, thereby serving as the attestation certification. At optional step 44, the documenting can be audited in the future. In this manner, corporate or government compliance can regularly be attested-to. It also serves to assist in troubleshooting and/or verifying procedures of the life cycle management.

At step 46, it is determined whether any more stages of the life cycle exist. If not, the life cycle is complete, and so is the attestation, per policy management thereof. If more stages exist, however, advancement to the next stage occurs at step 48. The steps of evaluating the criteria of the stage, per the policy, per the evaluators and computing configuration data for that stage repeats, at step 40, and continues until all stages are eventually evaluated.

In the event any one stage of the life cycle fails in its evaluation at step 40, a step of corrective action 52 is undertaken to assist in making the stage meet the policy for that stage. In this regard, numerous troubleshooting techniques are readily conjured-up. For instance, if the computing configuration data for a stage fails because of insufficient memory, a corrective action would relate to increasing memory and trying again. In that a near infinite number of corrective actions are possible, they are not discussed herein in detail. Eventually, the stage will pass at step 40 and processing will continue or it will forever fail. While forever failing creates the possibility of an endless loop of management, skilled artisans will eventually abandon the process if it indeed cannot be solved.

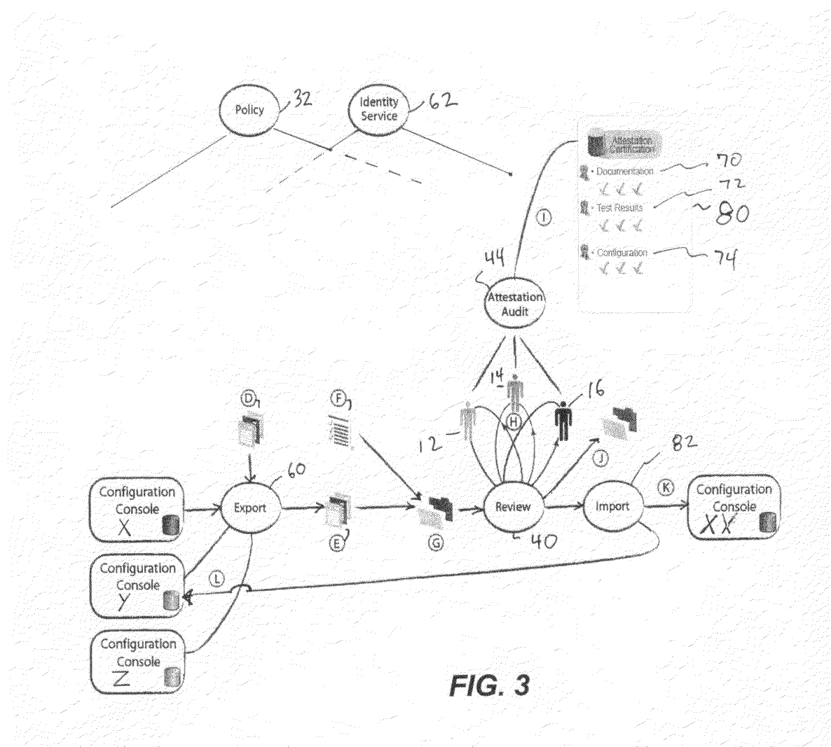

In various other optional embodiments, notifying personnel of the enterprise of the failed stage is given at step 54. In this way, the parties responsible for management will be made aware of management issues in the life cycle. Although not shown, a step of logging the notice (or logging any event of the flow chart 30) may also occur to assist in documenting the management, to assist in troubleshooting, or simply to serve as an historical record, or the like. At step 50, an option of redefining a previous stage is also given. This, however, will be described in more detail with regard to FIG. 3, e.g., configuration console XX.

With reference to FIG. 3, the invention proceeds in the following detailed manner:

Preliminarily, however, a configuration console X, Y or Z is common to the art. While the invention will operate without integration with the configuration console, in an embodiment the configuration console is modified to provide the invention's methods and mechanisms. In an embodiment the console is also an Orchestrator, a part of the Data Center Management product offering by Novell, Inc. Regardless of form, the computing configuration information is exported 60 from the configuration console X as per an export specification set forth at D to one or more files at E.

In one embodiment, the purpose of D is to specify the format and contents of E as per the structures and mechanisms provided by the configuration console. For example, the configuration console X is a highly sophisticated console where the configuration data is stored in data structures specific to the configuration console X. In this case, D specifies the API interactions with the configuration console, the content that is to be obtained via the API, and the final format of E. In another embodiment, configuration console Y manages the configuration data but has no API. In this case mechanisms are used to locate the configuration data held by the configuration console Y and E is formatted according to D. In still another embodiment, configuration console Z is a simple collection of files that are arranged to create E. In any case, the result is the creation of E which is a coalesced collection of documents or data that represents the configuration to be reviewed by evaluators per each stage of the life cycle. It is also established per the overarching policy of the organization. In a particular working example of the invention, the computing configuration data is the virtualization specifications created by the Orchestrator.

Also, the configuration consoles are identity-enabled, per users thereof, and provide the output needed for E with attached identities using the Identity Service 62. In other embodiments, the export function 60 attaches the identities to the various components of E. In still another embodiment, identity is not specifically associated with the components of E.

At F, documentation external to the configuration console is gathered and a final collection of all configuration and documentation constituting what is needed to be approved for stage, and then for stage advancement, is collected at G. In an embodiment, G is also associated with an identity via the identity service 62.

At the review function, step 40, the contents of G are reviewed by the evaluators 12, 14, 16 via one or more predetermined or dynamic workflows H specific to the stage of the life cycle under evaluation. In one embodiment, the workflow is provided by the known IDM 3 product from Novell, Inc., and not described herein in further detail. In another embodiment, the evaluators have workplace identities or roles (described earlier) for providing the approval in the form of an attestation certification by way of I. Representatively, this includes various documentation 70, test results 72 or configuration information 74. Also, apportioning of the evaluation can occur per the various evaluators based on identities (earlier given as a working example of a system administrator, an electrician and an accountant). In this regard, the evaluators each attest to certain portions of the policy for the region of knowledge, whereby all the evaluators must agree that the review is successful before advancement to the next stage can occur. Alternatively, multiple evaluators can provide redundancy or backup to other evaluators. They can even represent a management hierarchy that sequentially performs evaluation of a part of the data according to their role. Regardless, the final approvals are represented as attestations in an Attestation Certification data store 80 (written and/or electronic). Alternatively, the final approvals are represented as a collection of approvals and documents via J. In either, digital signatures are contemplated as are auditing 44 of either or both.

Once approved, the configuration of the console X is advanced to the next stage of the life cycle. As part of the advancement, the approved configuration is imported 82 or redefined, e.g., optional step 50, FIG. 2, into a configuration console XX, via the step K, as a separate configuration which allows the configuration console XX to command a computing configuration separate from the one at the beginning of the review cycle, e.g., computing configuration X becomes XX. Alternatively, the computing configuration X is merely approved and the same configuration is then logically moved to the new stage in the life cycle (represented by L, or step 48, FIG. 2). In other embodiments, the original configuration data is a collection of files and the collection of files is provided to a new owner for continued involvement in the life cycle and access control specifications are changed or configurations copied as per policy to effect the change in the life cycle. Naturally, skilled artisans can contemplate other embodiments per advancement of stages of the life cycle and such need not be described in more detail here.

The invention may also be augmented with a history mechanism to allow for roll-back functionality to known or earlier approved configurations. For instance, virtual machines as part of the data center can be defined by a single declaration. Then, to the extent review at step 40 does not produce a passed state, a corrective action 52, FIG. 2, contemplates rolling the declaration back to a stage known to have sufficient characteristics to operate to avoid losing operability. This functionality, however, is well known in the art and not described herein in more detail. It does represent, nonetheless, a profitable extension to existing implementations of the invention.

Certain advantages of the invention over the prior art should now be readily apparent. For example, stage-by-stage evaluation of the life cycle of a data center, founded per a predetermined policy, makes management of the data center comprehensively known from inception to full deployment and overcomes ad hoc management. Nuances such as documenting, auditing, notifying, etc., provide additional techniques for solving problems, certifying government or corporate compliance with laws, rules, guidelines, etc., or simply providing historical records. Evaluation by identity-based reviewers also preemptively positions the best persons in the position of making decisions regarding stages of the cycle. Other exemplary features include testing, documenting, notice and auditing functions, and machine and data center configurations, to name a few.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of the other figures.

1. A method of managing a life cycle, comprising:
defining a plurality of stages of the life cycle;
defining one or more criteria indicating a successful evaluation of each of the stages of the life cycle;
determining whether the one or more criteria are achieved per a first stage of the plurality of stages of the life cycle, the determining including evaluating at least one of a policy, an evaluator identity, and an attestation certification; and
if achieved, advancing to a next stage of the plurality of stages of the life cycle.

2. The method of claim 1, further including determining whether the one or more criteria are achieved per the next stage of the plurality of stages of the life cycle.

3. The method of claim 1, repeating a step of determining whether the one or more criteria are achieved per the each of the stages of the life cycle until all stages are evaluated, but only advancing from one stage to another stage upon achieving the successful evaluation.

4. The method of claim 1, wherein the defining one or more criteria further includes defining an attestation audit including a computing configuration, a test of the configuration, and a test result of the configuration.

5. The method of claim 1, further including redefining the first stage of the plurality of stages of the life cycle upon the successful evaluation of the determining.

6. A method of managing a life cycle, comprising:
defining a plurality of stages of the life cycle;
defining one or more criteria indicating a successful evaluation of each of the stages of the life cycle; and
per one said stage at a time, repeating a step of determining the successful evaluation of the each of the stages of the life cycle until all the stages are evaluated, but only advancing from one stage to another stage upon achieving the successful evaluation, the determining including evaluating a policy, an evaluator identity, or an attestation certification.

7. The method of claim 6, further including providing a plurality of consoles one of which is redefined for a next said step of determining for a next stage of the stages of the life cycle upon the successful evaluation of the determining of a previous stage of the stages of the life cycle.

8. The method of claim 6, wherein the defining the plurality of stages of the life cycle further includes an installment configuration, a testing of the installment configuration, a limited deployment of the installment configuration, or a full deployment of the installment configuration in an enterprise.

9. The method of claim 6, wherein the defining one or more criteria indicating the successful evaluation of each of the stages of the life cycle further includes defining a configuration of a computing device of a data center, a subnet, a storage binding, or a test of the configuration.

10. The method of claim 6, further including implementing a data center having the life cycle being managed as a plurality of virtual machines, the defining the plurality of stages of the life cycle further including defining a progression of the virtual machines from inception of an individual virtual machine to deployment of an entirety of the virtual machines in an enterprise in which the data center exists.

11. A method of managing a life cycle, comprising:
providing a policy defining a plurality of stages of the life cycle and one or more criteria indicating a successful evaluation of each of the stages of the life cycle;
according to the successful evaluation of the one or more criteria for a first stage of the stages of the life cycle, attesting to whether the policy is satisfied for the first stage;
if satisfied, advancing to a next stage of the plurality of stages of the life cycle;
according to the successful evaluation of the one or more criteria for the next stage, attesting to whether the policy is satisfied for the next stage; and
repeating the advancing and attesting steps as many times as necessary until all the stages of the life cycle are evaluated.

12. The method of claim 11, wherein the step of providing the policy further includes promulgating written or electronic documents that one or more evaluators of an enterprise in which the life cycle is being managed can utilize during the steps of attesting.

13. The method of claim 11, wherein the steps of attesting further includes testing a computing configuration of a data center according to a predetermined test defined by the policy.

14. The method of claim 11, wherein the steps of attesting further includes storing written or electronic attestation certificates of the attesting.

15. The method of claim 14, further including auditing the stored attestation certificates.

16. The method of claim 11, wherein the steps of attesting further includes multiple evaluators of an enterprise in which the life cycle is being managed each attesting to the satisfaction of a portion of the policy.

17. The method of claim 11, where the step of providing the policy further includes establishing attestation rights of evaluators of an enterprise in which the life cycle is being managed according to an employment identity within the enterprise.

18. A method of managing a life cycle of a data center of an enterprise, comprising:
providing a policy of the enterprise defining a plurality of stages of the life cycle and one or more criteria indicating a successful evaluation of each of the stages of the life cycle, the policy establishing attestation rights of one or more evaluators of the enterprise according to an employment identity within the enterprise; and
by the one or more evaluators per one said stage at a time, repeating a step of attesting to whether the policy is satisfied for each of the stages of the life cycle until all the stages are evaluated, but only advancing from one stage to another stage upon satisfactorily meeting the policy of said one said stage.

19. The method of claim 18, further including taking corrective action to satisfy the policy if the policy is not satisfied during the step of attesting.

20. The method of claim 19, further including notifying personnel of the enterprise when the policy is not satisfied during the step of attesting.

21. The method of claim 18, further including documenting each said step of attesting.

22. The method of claim 21, further including auditing the documenting.

23. The method of claim 18, further including revising the policy.

24. The method of claim 18, wherein the one or more evaluators includes multiple said evaluators each apportioning the step of attesting to whether the policy is satisfied for each of the stages of the life cycle until all the stages are evaluated.

25. The method of claim 18, further including defining a computing configuration per a single machine of the data center.

26. The method of claim 25, further including defining a computing configuration of an entirety of the data center having the single machine.
